(19) United States
(12) Patent Application Publication
(10) Pub. No.: US 2008/0301984 A1
(43) Pub. Date: Dec. 11, 2008

(54) CARD VIEWING DEVICE AND METHOD

(76) Inventor: David Singer, Dallas, TX (US)

Correspondence Address: HITCHCOCK EVERT LLP, P.O. BOX 131709, DALLAS, TX, 75313-1709, US

(21) Appl. No.: 11/759,529

(22) Filed: Jun. 7, 2007

(51) Int. Cl. G09F 11/00; G02B 27/02

(52) U.S. Cl. 40/366; 40/1

(57) ABSTRACT

A method and apparatus for card viewing used to select desired layered compound images is disclosed. The device includes viewing windows, slots, and various card types. The cards, each of which may contain an element of the compound image to be formed are inserted into the slots in a prescribed manner such that layered combinations may be viewed through viewing panes. Some embodiments may include a background card to place the layered combination in context, or, by excluding the background card, the compound image may be placed against a desired background such that a portion of the background remains visible with the compound image superimposed thereon. In one embodiment, the method and apparatus may be used to select art frame and mat design combinations in connection with representations of works of art and desired backgrounds.

### FIELD OF THE INVENTION

The invention relates to devices and methods for viewing cards. Specifically, the invention relates to devices that are used in selecting combinations of layered patterns displayed on cards wherein portions of each card are simultaneously visible such that the combination of cards creates a compound image. For example, the cards could display patterns representing frames, mats, images, and backgrounds, such as would be found in framed artworks, and the apparatus may be used to select desired combinations of those frames, mats, images, and backgrounds.

### BACKGROUND OF THE INVENTION

Devices that present various layer combinations for evaluating, comparing and selecting desired layer combinations do not allow all the advantages that are combined in the current invention. The example of selecting frames, mats, images and backgrounds for framed art is used to describe the invention, but the invention should not be limited to this example. Another example of the utility of the present invention is the cosmetics industry, wherein the cards could be used to display various skin tones in combination with various cosmetics. The invention allows the use of representations of different patterns to be easily handled and viewed. The device also permits the easy interchange of various patterns allowing various possible combinations to be efficiently evaluated. Some embodiments of the invention include multiple viewing panes that allow various combinations to be viewed simultaneously. These advantages are achieved by the current invention's novel design.

### SUMMARY OF THE INVENTION

In one embodiment, the apparatus of the present invention is comprised of first, second, third and fourth side elements joined together to create a generally rectangular outline having a void or viewing pane, at its center. In a preferred embodiment, the apparatus may also include one or more center struts dividing the viewing pane into two or more independent viewing panes. In one or more of the side elements, the apparatus may also include one or more slots into each of which a design card may be inserted. By inserting a design card into one of these slots, the design contained on the card may be viewed through one or more of the viewing panes. By adding additional cards, each of which may be designed such that it may display a design without completely obscuring the designs of other cards in the apparatus, a compound image may be formed which may be viewed through one or more of the viewing panes. For example, in an embodiment suitable for creating representations of framed art, a number of design cards representing various elements of framed art such as the art to be framed, one or more mats, a frame, and/or the background on which the art is to be hung, may be employed. By inserting these design cards into the present apparatus such that at least a portion of the design contained on each card is visible, a compound image representing the final framed art may be created. This compound image may be evaluated and various combinations of art, mats, frames, and/or backgrounds may be substituted until a desired combination is found.

As will be appreciated, in the previously described embodiment, because the apparatus contains a viewing pane which allows a user to see through the apparatus to a background behind it, the user may compare the various combinations of design cards in the context of any desired background. This option is advantageous because the background could be a wall on which a framed image is to be hung, a users own skin, or any other background suitable for the application in which the apparatus is used. However, in an alternate embodiment, the apparatus of the present invention may also comprise a wall spanning and joining the first, second, third, and fourth side elements such that it obscures the viewing pane when the apparatus is viewed from a particular side. In this embodiment, while a user would be unable to see through the apparatus, a combination of design cards could still be used to create a compound image. This embodiment may be advantageous where the combination of design cards is to be viewed against a constant, neutral background or where the user may not know the background against which the finished art is to be hung.

In a further embodiment of the device, four slots may be included in one of the side elements and at least two viewing panes may be incorporated into the device. Along with one or more design cards, this embodiment may also include a background card that is designed to be placed in the slot furthest from the viewer. The background card is viewable through the viewing pane, and is not completely obscured by any design cards also inserted in the device. This embodiment allows a user to view various combinations of design cards in the context of an intended background when the actual background is unavailable or at a different location, or the user may determine the desired background by interchanging background cards.

In further embodiments of the present invention, the size of the design cards relative to the apparatus may be varied. For example, a single design card may span more than one viewing pane, or cards may be sized such as to be viewed from only a single pane. When smaller design cards are used, more variation in design card combinations may be simultaneously displayed. Similarly, the length of the slots into which the design cards are inserted may be varied to accommodate different size design cards. Thus, any combination of slots and cards may be utilized to provide various advantages depending on the desired use of the device.

Other embodiments of the invention can include locking mechanisms to prevent cards from falling out of the device or moving out of alignment. The lock can be specific to each card allowing some to be locked in place while others are interchanged. A locking mechanism may be a slide that can be engaged when pushed towards a card to hold the card in place, and may be disengaged by pulling the slide away from the card allowing the card to be removed. Other locking designs will be readily apparent to those skilled in the art. In another embodiment, the device is contoured to have smooth edges and includes grip portions along the edges for easier handling.

In another embodiment, the design cards may be designed as overlays such that successive stacking of cards produces a composite image, but where each card is not necessarily designed to permit viewing of underlying cards. Rather, each card may contain only a single color and the stacking of cards will produce a mix of these colors. For example, a first card may contain an image printed with only red ink, while a second card may be printed with the same or a similar image, but printed with only blue ink. By stacking the cards, the resultant image may be similar to the images displayed on the first and second cards; however it may appear purple due to the blending of the colors printed on the two cards.

This embodiment allows the combinations of bases, colors, and highlights to be evaluated against specific images to determine a desired look. Various cards may separately overlap portions of the background image without overlapping purely transparent portions of intermediary cards. The base shade, color, and highlight portions may be opaque or semi-transparent depending on the desired look and use. The cards may also include additional structural portions that may or may not be transparent.

The embodiments described herein contemplate comparing only two designs at a time, but the invention may be used to compare other numbers of designs. Additionally, the number and placement of slots and card designs may be varied and remain within the scope of the invention. The embodiments are not limited to the descriptions given and may incorporate other elements. The embodiments also may incorporate various combinations of the elements described, known, or yet to be discovered and remain within the scope and spirit of the invention.

The invention may be constructed in many ways. For example, a three-piece design may include front and back pieces as well as a top piece defining the slots, each made of plastic. The top piece may be designed to fit in a groove located at the top of the front and back pieces, and held in place when the front and back pieces are attached to each other. The manner of attachment can also vary greatly and may allow the pieces to be easily assembled and separated from one another. Attachment may be achieved with adhesives, screws, nails, snaps, latches, or any other manner of attaching items together. Other manners of construction known or yet to be discovered remain within the scope and spirit of the invention.

### SUMMARY OF THE DRAWINGS

A more complete understanding of the invention and its advantages will be apparent from the following detailed description when taken in conjunction with the accompanying drawings in which:

FIG. 1 depicts a perspective view of the invention with the cards removed;

FIG. 2 depicts a front view of the invention;

FIG. 3 depicts a top view of the invention;

FIG. 4 depicts a front view of an alternate embodiment of the invention;

FIG. 5A depicts a front view of a background card;

FIG. 5B depicts a front view of an image card;

FIG. 5C depicts a front view of two mat cards; and

FIG. 5D depicts a front view of a frame card.

### DETAILED DESCRIPTION

As will be appreciated by one having skill in the art, the edge of the device is any portion not considered the front or back, including but not limited to the top, bottom, and sides. The front is considered the face of the device which is viewed while using the device to view layered designs.

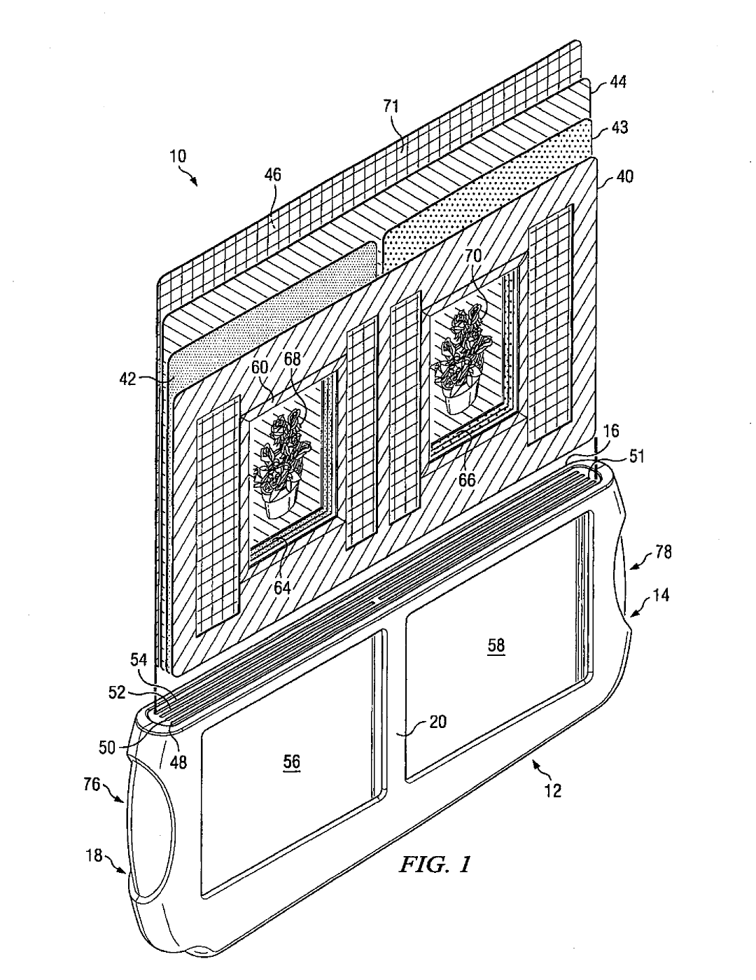

FIG. 1 depicts one embodiment of the card viewing device 10. Card viewing device 10 may be comprised of first, second, third and fourth sides 12, 14, 16, and 18 respectively as well as, in the embodiment depicted, center strut 20. As shown, card viewing device 10 is a generally rectangular frame, with first and third sides 12 and 16 forming the major axis or long sides of the frame, and second and fourth sides 14 and 18 forming the minor axis or short sides of the frame. At least one opening in card viewing device 10 is formed by first, second, third and fourth sides 12, 14, 16, and 18. In the embodiment shown, center strut 20 generally bisects and connects first and third sides 12 and 16 and also bisects the opening in card viewing device 10 to form two viewing panes 56 and 58. Center strut 20 may provide additional structural rigidity to card viewing device 10 and also serves to separate the images to be formed in card viewing device 10.

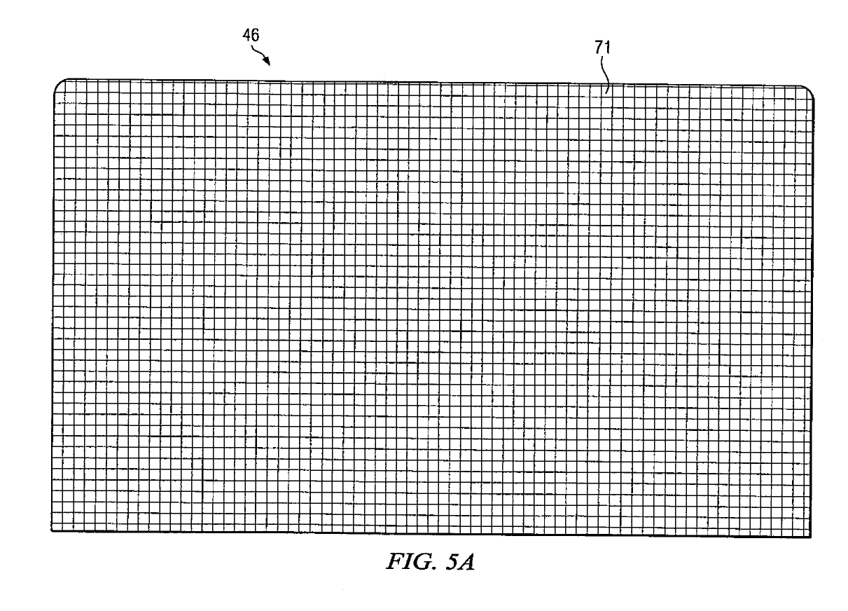

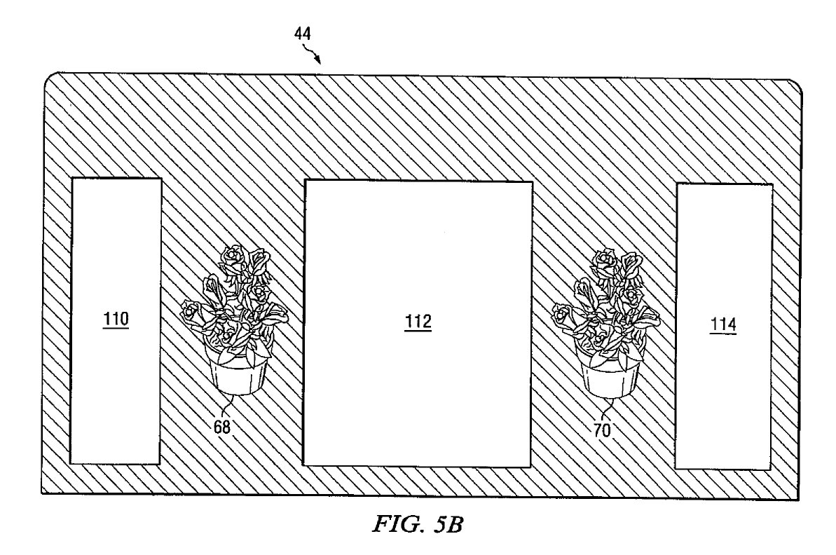

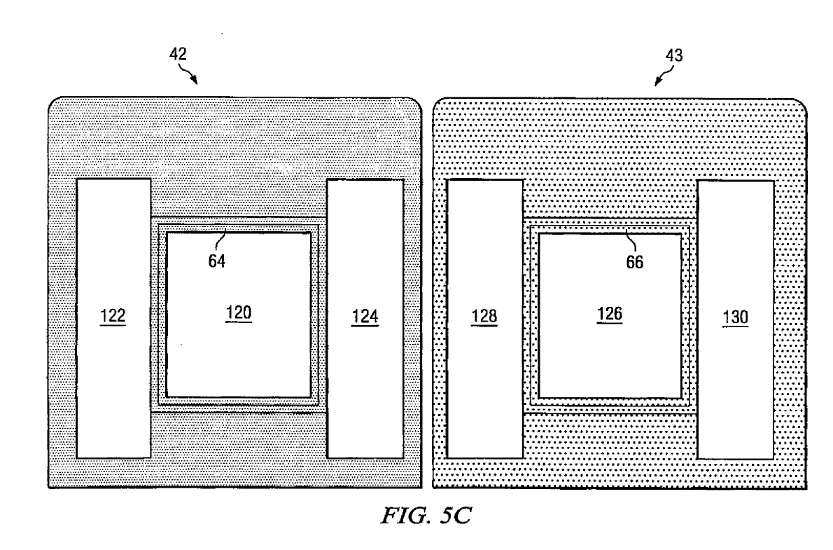

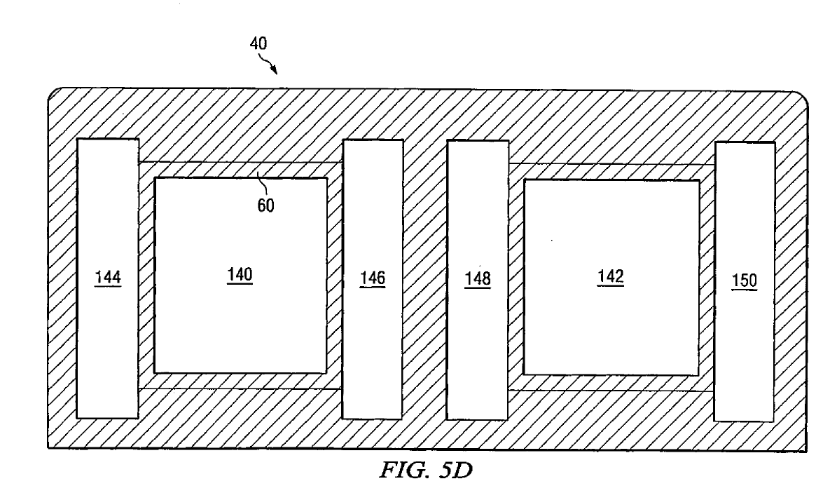

This embodiment shows the invention having first, second, third, fourth and fifth cards 40, 42, 43, 44, and 46 respectively, positioned to engage corresponding first, second third, fourth and fifth slots 48, 50, 51, 52 and 54 formed in third side 16. As shown, the device has two viewing panes 56 and 58. In this embodiment, first card 40 includes a first design 60, which for the purposes of this embodiment, may be a design representing a picture frame. Furthermore, first card is of a size such that it extends substantially the length of card viewing device 10 and is at least partially visible in both viewing panes 56 and 58. As will be discussed in greater detail below in relation to FIG. 5D, first card 40 is constructed such that only a portion of first design 60 is visible through viewing panes 56 and 58 when first card 40 is inserted into first slot 48. Note that in alternate embodiments, first design 60 may not be consistent across all of first card 40 such that the portion of first design 60 visible in viewing pane 56 may be different than the portion of first design 60 visible in second viewing pane 58. By varying the first design 60 in this manner, additional compound designs may be formed.

Similarly, second and third cards 42 and 43 include second and third designs 64 and 66, which for the purposes of this embodiment, may be designs representing picture mat designs. In this particular embodiment, second and third cards 42 and 43 are depicted as being approximately half the length of first, fourth, and fifth cards 40, 44 and 46 respectively. At this size, each of second and third cards 42 and 43 extends only approximately half the length of card viewing device 10 and is visible in only one of viewing panes 56 and 58. By using cards of this size, each of which may depict a different pattern or image, a user is able to more efficiently depict alternate compound images for comparison. As will be discussed in greater detail below in relation to FIG. 5C, second and third cards 42 and 43 are constructed such that only a portion of second and third designs 64 and 66 are visible through viewing panes 56 and 58 when second card 42 is inserted into second slot 50 and third card 44 is inserted into third slot 52.

Fourth card 44 includes images 68 and 70 which may be the same image or depict different images, again to increase the number of compound designs simultaneously viewable in the device. For the purposes of this embodiment, images 68 and 70 may be images representing photographs or works of art. When fourth card 44 is inserted into fourth slot 52, images 68 and 70 are visible through viewing panes 56 and 58 as well as voids in first second, and third cards 40, 42, and 43.

Finally, fifth card 46 may be inserted into fifth slot 54 such that it completely blocks viewing panes 56 and 58 as well as any voids created by first, second, third or fourth cards 40, 42, 43 or 44. Fifth card 46 may include a fifth design 71, such as a pattern or solid color representing a background. When the present device is used to create compound images representing framed art, fifth design 71 depicted on fifth card 46 may represent the color of a wall or other background on which the art or compound image may be placed.

In alternate embodiments, fifth card 46 may be omitted such that a user of the device may be able to view a background scene, such as a wall on which an artwork is to be placed, through viewing panes 56 and 58 as well as card windows in first, second, third, and fourth cards 40, 42, 43, and 44, as discussed in conjunction with FIGS. 5B, 5C, and 5D. By so doing, the user is able to visualize the finished artwork in place on an existing wall.

FIG. 1 also depicts an embodiment of the invention having two contoured grip portions 76 and 78. The contoured grip portions 76 and 78 are part of a preferred embodiment, but are not necessary aspects of the invention. The number of grip portions, contoured portions, the grade of any contour, and variation of any other similar portions are within the scope and spirit of the invention.

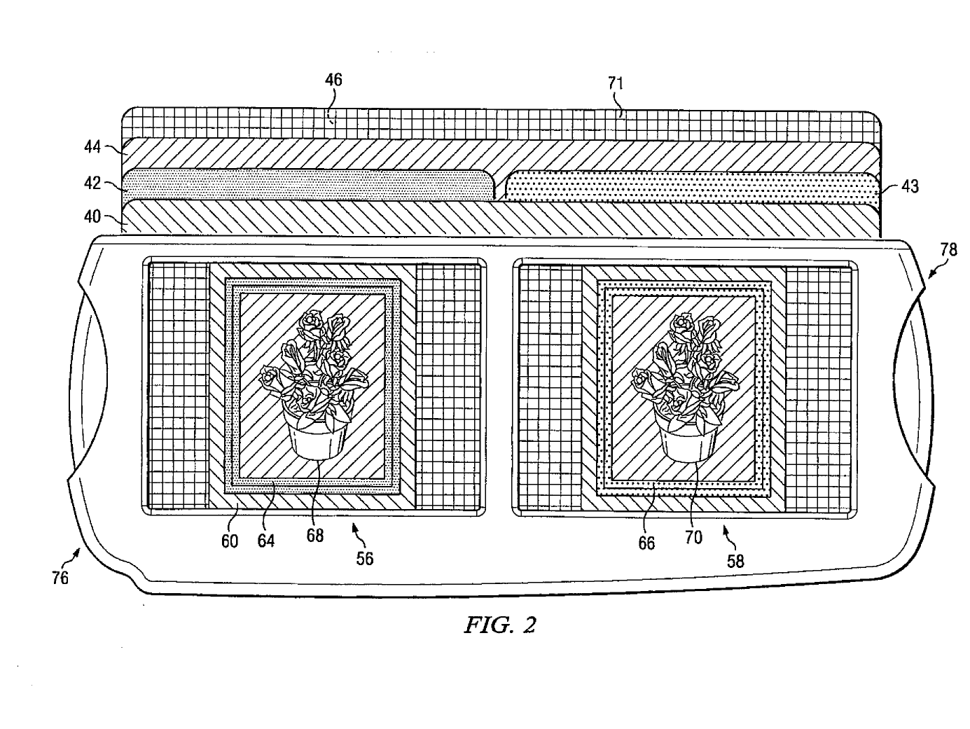

FIG. 2 shows a front view of the invention with cards 40, 42, 43, 44, and 46 inserted in slots 48, 50, 51, 52 and 54, respectively. In this view, it can be seen that image 68, as well as portions of first design 60, second design 64, and fifth design 71 are visible through viewing pane 56 while image 70, and portions of first design 60, third design 66 and fifth design 71 are visible through viewing pane 58. Again, the various card windows required to allow viewing of various portions of various designs will be discussed in greater detail in connection with FIGS. 5B, 5C, and 5D.

The various cards can be designed in various sizes to create layered tabs to ease the handling of the cards. Many designs may be used to ease handling and interchanging the cards such as the shown stacked tabs, tabs next to each other, or other known or yet to be discovered methods to ease interchangeability and handling of the cards and all remain within the scope and spirit of the invention.

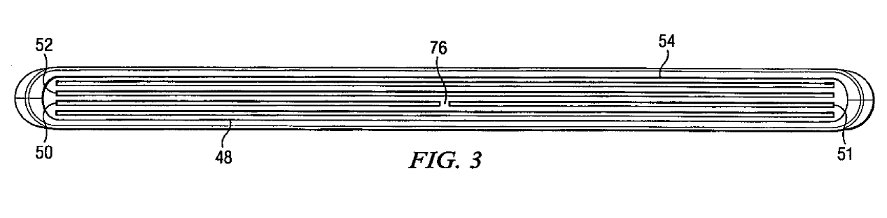

FIG. 3 shows a top view of the previously described embodiment having first through fifth slots 48, 50, 51, 52, and 54, respectively. As can be seen in this figure, the slots may take a variety of forms. For example, first, fourth and fifth slots 48, 52 and 54 extend for substantially the entire length of the device, while second and third slots 50 and 51 each extend only approximately half the length of the device. Alternate designs are of course possible without departing from the scope of the invention. Thus, while this embodiment is depicted having three full length slots and two half length slots, the size, length, number, and other attributes of the slots may be varied and remain within the scope and spirit of the invention.

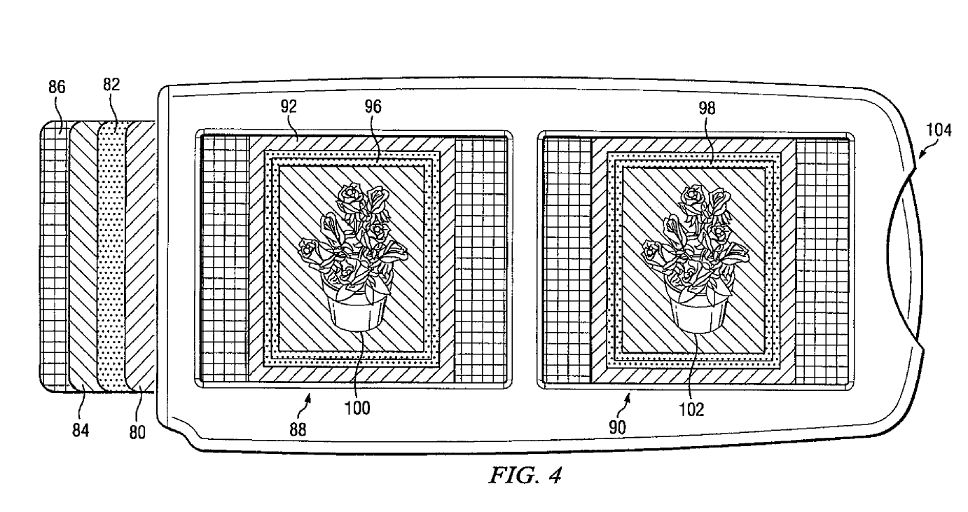

FIG. 4 depicts another embodiment of the invention having full length first through fourth cards 80, 82, 84, and 86 inserted through slots formed in one or more of the short sides 14 and/or 18. This embodiment shows a first viewing pane 88 and a second viewing pane 90. First card 80 may include a first design 92. First design 92 is visible through first viewing pane 88 and second viewing pane 90. Second card 82 may include a second design 96 visible through first viewing pane 88 and second viewing pane 90. Third card 84 may include first image 100 and second image 102. Finally, fourth card 86 may be used to provide a background image. With any of first through fourth cards 80, 82, 84, or 86, the design or image depicted thereon may be varied across the card such that the portion of the card visible in viewing pane 88 may not be identical to the portion of the card visible in viewing pane 90.

As with the previously discussed embodiment, in this embodiment, the combination of first through fourth cards creates a compound image visible through viewing panes 88 and 90. Also, because the various designs and images may be varied, the compound images visible in viewing panes 88 and 90 may not be identical. In this way, a user may compare and contrast different compound images and the elements that form the compound images.

FIG. 5A depicts fifth card 46 as discussed in FIG. 1 and FIG. 2. Fifth card 46 may be used as a background for the compound images formed by other cards inserted in the device. As previously discussed, fifth card 46 may also be removed from the device to allow a user to view compound images superimposed over an actual background.

FIG. 5B depicts fourth card 44 as discussed in FIG. 1 and FIG. 2. Fourth card 44 is shown with images 68 and 70 and three cut-outs or voids 110, 112, and 114. Cut-outs 110, 112 and 114 allow a user to view portions of fifth design 71, which is typically a background image with images 68 and 70 superimposed thereon. As used herein, the term cut-out refers to an area of a card in which portions of underlying cards or backgrounds may be visible.

FIG. 5C depicts second and third cards 42 and 43 as discussed in FIGS. 1 and 2. Second card 42 is shown with second design 64 and cut-outs 120, 122, and 124. Third card 43 is shown with third design 66 and cut-outs 126, 128 and 130. Cut-outs 120, 122, 124, 126, 128, and 130 allow a user to view images 68 and 70 as well as portions of fifth design 71.

Finally, FIG. 5D depicts first card 40 as discussed in FIG. 1 and FIG. 2. First card 40 is shown with first design 60 and cut-outs 140, 142, 144, 146, 148, and 150. Cut-outs 140, 142, 144, 146, 148, and 150 allow a user to view images 68 and 70, portions of second and third designs 64 and 66 as well as portions of fifth design 71. Thus, when first through fifth cards 40, 42, 43, 44 and 46 are inserted in the device, a user is able to view, through viewing pane 56, a compound image consisting of a portion of first design 60 (which could represent an art frame), a portion of second design 64 (which could represent a mat), image 68, and a portion of fifth design 71 (which could represent a background). The user can simultaneously view, through viewing pane 58, a second compound image consisting of a portion of first design 60, a portion of third design 66, image 70, and a portion of fifth design 71. As the designs and images may be varied, the user may compare different combinations to find a preferred solution.

While the invention has been described with reference to a preferred embodiment, it should be understood that any reference to a particular use or uses of the described invention are included for illustration and should not be construed as any limitation. Changes in the materials used and any method of construction, or combination and arrangements of parts may be made without departing from the scope of the invention.

1. A card viewing device having a major and a minor axis, comprising:
first, second, third and fourth edges forming a frame having at least one opening therethrough wherein at least one of said first, second, third, or fourth edges includes one or more slots formed therein; and
at least two cards independently operably engageable with at least one of said one or more slots such that at least a portion of each of said cards is visible in said opening.

2. A card viewing device as in claim 1 wherein each of said at least two cards has designs and/or images thereon.

3. A card viewing device as in claim 2 wherein said one or more slots comprises at least four parallel slots formed in one of said first, second, third, and fourth sides.

4. A card viewing device as in claim 3, wherein said at least two cards comprises four cards, each independently operably engageable with one of said four parallel slots.

5. A card viewing device as in claim 2, wherein at least one of said at least two cards comprises one or more cut-outs through which is visible said designs and/or images on at least one other of said at least two cards.

6. A card viewing device as in claim 2, wherein at least one of said at least two cards has at least two disparate designs and/or images thereon.

7. A card viewing device as in claim 6, wherein said card viewing device has at least two openings therethrough.

8. A card viewing device as in claim 7, wherein a first of said two disparate designs and/or images is visible in a first of said at least two openings and a second of said two disparate designs and/or images is visible in a second of said at least two openings.

9. A card viewing device as in claim 1, wherein said one or more slots comprises one or more slots which extend along substantially the entire length of said major axis of said card viewing device, and at least one slot which extends only approximately half the length of said major axis of said card viewing device.

10. A card viewing device as in claim 1, wherein at least one of said at least two cards extends along substantially the entire length of said major axis of said card viewing device and at least one other of said at least two cards extends only approximately half the length of said major axis of said card viewing device.

11. An apparatus for creating and comparing compound images comprising:
a frame operable to support and display a plurality of cards; and
a plurality of cards, each comprising one or more designs and/or images;
wherein when said cards are displayed in said frame, a compound image is formed comprised of portions of the designs and/or images displayed on each of said cards.

12. An apparatus for creating representations of framed art comprising:
a frame operable to support and display a plurality of cards;
a first plurality of cards, each of which is operable to display a design or image representing an art frame;
a second plurality of cards, each of which is operable to display a design or image representing an art mat;
a third plurality of cards, each of which is operable to display a design or image representing a work of art; and
a fourth plurality of cards, each of which is operable to display a design or image representing a background;
wherein the display of at least one card selected from said first, second, third and fourth plurality of cards in said frame creates a compound image in which at least a portion of each of said cards selected from said first, second, third and fourth plurality of cards is simultaneously visible.

13. A method for creating a compound image comprising the steps of:
selecting a first image from a first plurality of images;
selecting a second image from a second plurality of images;
selecting a third image from a third plurality of images;
selecting a fourth image from a fourth plurality of images; and
arranging said images in a frame operable to simultaneously display at least a portion of each of said images.

14. The method of claim 13 further comprising the steps of:
evaluating the compound image resulting from the display of said images; and
removing at least one of said images and replacing it with another image selected from the plurality of images from which the removed image was originally selected.

15. The method of claim 14, further comprising the step of:
repeating said step of removing at least one of said images and replacing it with another image selected from the plurality of images from which the removed image was originally selected until a desired compound image is achieved.
